(19) United States
(12) Patent Application Publication
(10) Pub. No.: US 2005/0282110 A1
(43) Pub. Date: Dec. 22, 2005

(54) Method for removing a dental crown and apparatus therefor

(76) Inventors: Jack Goodman, Lusby, MD (US); Jere W. Glover, Annapolis, MD (US)

Correspondence Address: ERIC P. SCHELLIN, 6831 CLOISTERS DRIVE, \, Mc LEAN, VA, 22101, US

(21) Appl. No.: 11/108,462

(22) Filed: Apr. 19, 2005

Related U.S. Application Data
(63) Continuation-in-part of application No. 10/870,612, filed on Jun. 17, 2004, now Pat. No. 6,923,647.

(51) Int. Cl. A61C 3/03

(52) U.S. Cl. 433/118; 433/141

(57) ABSTRACT

Method and tool for fracturing the cement interface between a crown and a tooth or a fixture on a tooth and the tooth. The method is accomplished by positioning a clamp having a driven rapid impacting tool against one side portion of a crown or fixture covering the tooth. The working edge of the tool is covered with a first malleable metal cap and is in interfacing abutment with said crown or fixture. The opposed side of the crown or fixture is abutted against an anvil which is part of the clamp. The anvil is covered with a thicker second malleable cap.

This application is a c-i-p of patent application Ser. No. 10/870,612; filed: Jun. 17, 2004.

### FIELD OF THE INVENTION

The present invention relates to a dental tool and method of use, and more particularly, to a tool for fracturing the interface between two dental structures that have been adhesively secured together.

### BACKGROUND OF THE PRESENT INVENTION

Dental structures such as caps, crowns and bridges are bonded to natural tooth roots or implanted posts by well known conventional cements. It is equally well known, that the removal of cemented dental structures may be necessary for one or more of the following reasons:
(a) The occurrence of dental decay.
(b) To examine the vitality and pulpal involvement of an underlying tooth
(c) To repair cemented dental structures made defective by the wear of materials.
(d) The loss of selected supporting teeth.

It is also known that natural tooth roots are connected to bone structure by a matrix of connecting fibers. It is stated that the connecting fibers exhibit a resultant vector force which holds the tooth root in place, which vector force operates substantially along a longitudinal axis in the direction of the top to bottom of the tooth. Thus, properly directed impacting forces permit the use of short force magnitude but of high frequency to break or fracture the cement bonds holding the dental structure to the tooth root with a minimal detrimental effect to the fibers or natural tooth roots.

In the prior art, removal of dental structures such as caps, crowns and bridges was accomplished by often times sacrificing the tooth bearing the caps, crown or bridge or by the application of a rigid grasping means to the structure followed by a manual application of an impacting or leverage force in an attempt to break the cement bonds. However, prior art devices could apply only in exact magnitudes of impacting forces since manual means were used. Such manual means were further limited in that the oral cavity is not large enough to permit easy direct impacting to those dental structures located near the rear of the oral cavity. Other consequences of the use of prior art apparatuses are patient discomfiture, and inconvenience to the dentist occasioned by the cumbersome mechanical apparatus.

Some recent progress has been made by the use of diminutive ultrasonic probes for application to teeth to remove or loosen orthodontics and other dental structures, such as disclosed in U.S. Pat. Nos. 5,106,302 and 5,320,532 to Farzin-Nia et al.

Even more recently the art for removal of crowns and the like has been considerably advanced by the invention disclosed in Patent No. 5,547,300 to Goodman, the material therein is incorporated herein in its entirety.

### SUMMARY OF THE INVENTION

It is accordingly an object of the present invention to provide a more efficient apparatus for the removal of cemented dental structures.

It is another object of the invention to provide an apparatus for the removal of a cemented dental structure using precisely impacting forces directed essentially transversely to the longitudinal axis of said structure.

It is still another object of this invention to provide an apparatus for the removal of a cemented dental structure operable in confined regions of the oral cavity.

It is an object of this invention to provide an automatic apparatus thereby minimizing manual intervention for effecting the removal of a cemented dental structure.

It is another object of this invention to provide an apparatus for the removal of a cemented dental structure which apparatus includes a clamping means to hold the dental structure.

It is still another object of this invention to provide a piezoelectric transducer apparatus for the removal of a cemented structure wherein the piezo crystals are affixed to at least longitudinally extending sides of a steel core.

It is yet another object of this invention to provide a piezoelectrically driven device in a clamp wherein the steel core terminates in an impacting cone. The said cone has a thin copper cap affixed thereto. An anvil is provided and secured to the clamp and a thicker copper cap is affixed to the anvil. The crown is secured therein between.

It is yet another object of this invention to provide apparatus for the removal of a cemented dental structure which apparatus may be selectively coupled to any of a plurality of so-called permanent cap, crown or bridge structures.

The direction of application of impacting must be applied perpendicular to the plane of the cement of the structure. In this way the bond of the cement is fractured by shocking it with numerous low power but nevertheless high frequency shock waves. In use, the piezoelectric device with a cone covered with a thin copper shield is placed perpendicular to the axis of the tooth, at proximate the open end of the cap. The opposite side of the cap must be backed by an anvil. A thicker copper shield is positioned between the cap and the anvil as stated in the foregoing.

Preferably the anvil and the piezoelectric tool is positioned at the confronting legs of a vise-like device whereby the cap of the tooth is positioned there between in a gripping manner. The vise action results in maintaining constant contact of the piezoelectric tool through the thinner copper shield with the cap or crown which inhibits considerably the production of sound by the piezoelectric tool of the present invention, thereby making it more pleasant for the patient.

An important feature of the present invention resides in the fact that as the impacts occur from the piezoelectric tool, the copper shields become work hardened but not before it becomes conformed to the surface of the cap or crown that is being impinged.

The concept is to preferably flex the rim area of the cap or crown very rapidly after work hardening the copper shields but with a minimum of lateral displacement, of the order of approximately five microns whereby the cement is trapped and fractured between the inertia of the root or post on the flexing cap. It has been discovered that the fracture line begins at the point of abutment of the copper sheathed cone of the piezoelectric tool and extends around the tooth, post or root to the other side of the cap or crown. This greatly reduces the energy and time required to break the bond. There is no deleterious pulling force on the tooth, only tiny vibrations. Since there is no pulling or tugging on the tooth and the motion is small, large caps even with multiple posts or roots are loosened by fracturing the cement at each bond individually.

### BRIEF DESCRIPTION OF THE DRAWINGS

FIG. 1 is a schematic of the clamp in a side elevation.

FIG. 2 is a schematic showing the device of the invention employed with the crown in part in cross section.

FIG. 3 is the same view as in FIG. 2 with fracture in progress.

FIG. 4 is a cross sectional and schematic view of another embodiment;

FIG. 5 is a cross sectional and schematic view of still another embodiment;

FIGS. 6-9, are to the embodiment of FIG. 4 illustrating the action of the tool;

FIG. 10 is a cross sectional and schematic view of yet another embodiment, showing the operation thereof;

FIG. 11 is a cross sectional and schematic view of the embodiment of FIG. 10, showing the further operation.

### DETAILED DESCRIPTION OF THE INVENTION

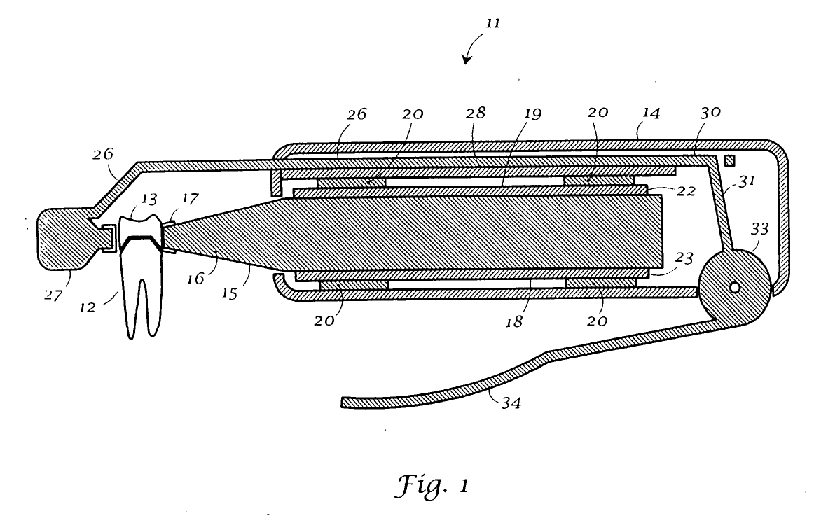

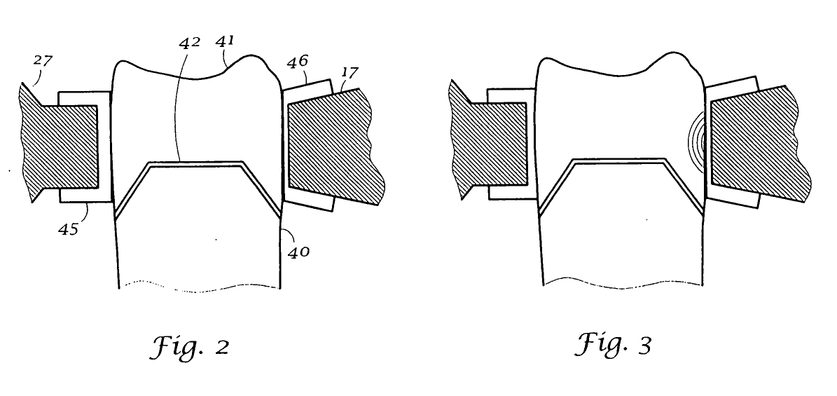

Attention is now directed to FIG. 1 where the device is shown, generally, at 11 which is depicted as being clamped about a tooth 12 which has a cap 13 thereon. The device 11 has a housing 14 which has mounted therein a piezoelectric device 15 consisting of an elongated steel four sided bar 16 that terminates in a truncated cone portion 17 at its distal end. The bar 16 has mounted on opposite surfaces piezoelectric crystals 18 and 19. These crystals are adhesively secured to the bar 16 by a conventional epoxy cement. The bar 16 and the piezoelectric crystals 18 and 19 are mounted in the housing 14 by rubber mounts 20. The piezoelectric crystals 18 and 19 are electrically connected to a source of electricity by electrically conducting wires 22 and 23.

The housing 14 has an elongated linearly spaced channel 25 in which is mounted a reciprocable movable metal flat member 28. The distal end 26 thereof terminates in an anvil portion 27 which is confrontingly mounted in regard to the truncated cone portion 17 and spaced therefrom detailed to accommodate the to-be treated crown or cap of a tooth.

The proximate end 30 of flat member 28 is operatively connected to an arm 31 which is arcuately mounted to hub 33. The hub 33 has an elongated handle 34. An operator grasps in one hand both the housing 14 and the handle 34. When the housing 14 and the handle 34 are squeezed together the anvil 27 moves linearly in the direction of the truncated cone 17. A tooth 12 with a to-be removed cap 13 is grasped between the anvil 27 and the truncated cone 17.

Attention is now directed to FIG. 2 which depicts in fragmentary details a tooth 40 having a crown 41 and a cement 42 there between. Positioned between the crown 42 and the anvil 27 is a cup 45 of relatively thick copper. At the truncated cone 17 is a thinner cup copper interface 46. Copper is the preferred material as it is very malleable. A combination of the clamping between the anvil and the truncated cone and the vibrations afforded by the piezoelectric device results in the copper surfaces touching the crown 41 conform to the surfaces of the crown 41. The copper cup 45 being thicker results in good holding characteristics while the thinner copper cup 46 on the truncated cone 17 permits the delivery of vibrations in a manner to spread the peak pressure.

The vibrations set up in the crown concentrate on the cement pulverizing it in situ with fracturing spreading in a ripple effect throughout the cement resulting in a complete loosening of the crown ready for subsequent removal.

It is submitted that a similar and applicable piezoelectric tool construction can be seen in U.S. Pat. No. 5,269,291 to Carter. This patent is incorporated herein in its entirety.

Once the fracturing has been completed the device 10 can be removed, followed by the removal of the cap 41. In the infrequent event that the fracturing is incomplete the device may be re-positioned for further impact impingement. At no time with the method of the invention is it necessary to apply pulling forces on the crown or tooth which can result in loosening of the tooth per se.

It will be appreciated that other drivers may be substituted for the pizeoelectric ultra sonic vibratory motor described in the foregoing. As a matter of fact it is not necessary that the driver be operable at an ultra sonic speed. In the following, there are disclosed two alternate drivers which comprise an air driven piston impact tool that is employed to loosen a conventional cap from a tooth and alternatively an air driven ball impact hammer. Both are useful in a dentist's office where compressed air is available at the patient's chair.

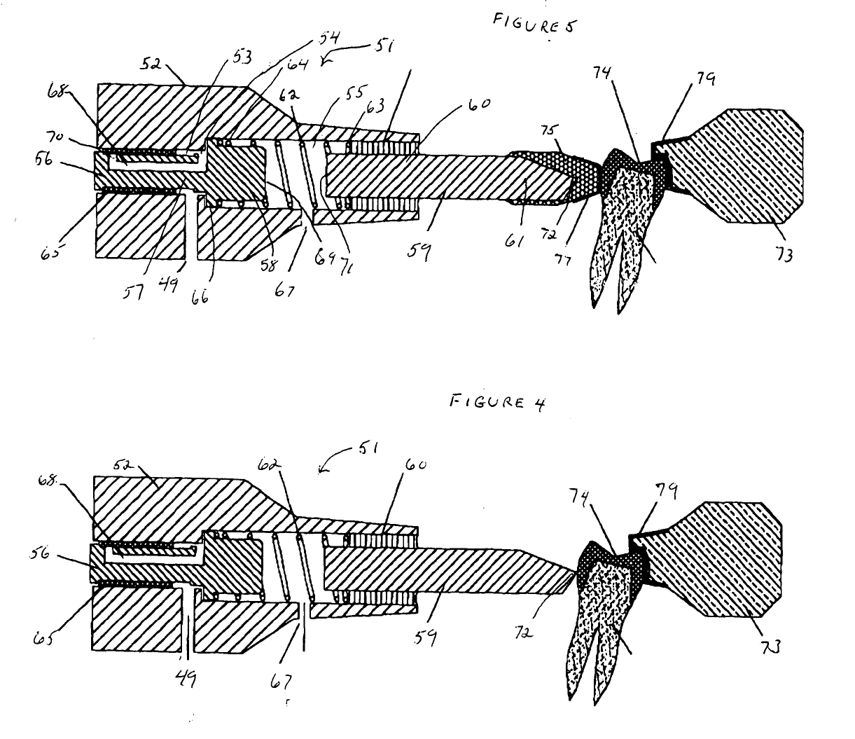

Accordingly, FIGS. 4 and 5 pertain to an air driven piston impact tool wherein, reference numeral, 51, generally, illustrates the air driven impact tool 51. The air driven impact tool 51 is shown in cross-section and is essentially schematic, thereby presenting the air driven motor with clarity. The two figures also show the air driven impact tool 51 is in an enlarged fashion so the drawings are not to scale.

The main body portion of the air driven motor has a tubular housing 52 which has therein an elongated centrally located tubular chamber 53 which consists of a first section 54 and a second section 55 which are axially disposed and interconnected so that one runs into the other. The first section 54 is rearward of the housing 52. The second section 55 is located forward of the first section 54, that is, the second section 55 which is to the right of the first section 54, as detailed in the accompanying drawings. The second section 55 has a larger diameter than the first section 54. The first section 54 is fitted with a piston 56 that consists of a tubular stem portion 57 and extending therefrom and forwardly a hammer portion 58 which extends into the second section 55. The second section 55 has resiliently mounted therein a chisel 59 that extends axially outwardly out of the second section 55. The housing 52 has a conduit 49 which is perpendicular to the first section 54 and is supplied with conventional fitting (not shown) by means of which air under pressure is introduced. The chisel 58 has a rearward portion 60 and a forward portion 61 which is to the right with respect to the drawings.

A helical spring 62 is concentrically located in said second section 55. The helical spring 62 is mounted at its end 63 thereof about the rear portion 60 of the chisel 58. The other end 64 of the helical spring 62 is mounted around the hammer portion 58. The said end of which abuts against the underside the of an annular flange 66 of the hammer 58. Section 55 has a front piston vent 67 through which air is vented. The first section 54 has a valve 65 which consists of a relatively small tube. The tube of the valve is concentric with respect to a major portion of the stem 57 of the piston. The stem of the piston 57 has located therein a conduit 68 which extends from near the backside of the piston to an opening 70 near the most rearward end of the stem 68. The portion of the tube covers that opening 70 to close egress to the ambient. The valve functions by being slid closed in one position thereby permits the air pressure to be built on the backside of the piston-hammer combination 56 & 58 which results in the latter being driven to the right. The surface 69 of the hammer 58 impinges on the surface 71 of the top of the chisel 61.

The air under pressure received through conduit 49 and the fitments thereof pressurizes the first section 54. The piston 56 and hammer 58 are driven to the right and against the top of the chisel at portion 60; the other end of which has a chisel edge 72 which is impacted against a side of a cap of a tooth, the latter which is be removed. Any build up of air pressure in the second section 55 and ahead of the front of the hammer is vented through perpendicularly disposed conduit 67. Inertia drives valve 65 axially concentrically to the right along the stem portion 57 of the piston 56. This motion uncovers the end opening 70 of the conduit located in the stem portion 57 of the piston 56 whereby the pressurized air build up in the first section 54 is vented out the backside of said first section 54. The relief of air under pressure permits the helical spring to operate to drive the piston-hammer combination back to its original position. When the stroke to the left is completed the air venting position to the rear is closed by tube valve 65 which completes its travel to the left under the aegis of inertia and the first section 54 is open again to the conduit 49 and its source of air under pressure to again cycle the piston-hammer combination to the right as before.

The air under pressure drives the piston-hammer combination 56 & 58 in one direction while opening of venting valve 65 which is opened under the aegis of inertia. The helical spring 62 operates to return the piston-hammer combination 56 & 58 to the left with the concomitant closure of venting opening 70.

The air driven impact tool of the above discussed tool comprises one side of an U-shaped tool as disclosed in issued patent No. 5,547,380 which is incorporated herein by reference. Instead of an ultra-sonic driver as taught in the patent, the air driven impact producing tool is now taught. The other side of the U-shaped tool comprises an anvil carrying member 73, shown in cross section in FIGS. 4 & 5 discussed in the immediate foregoing. By way of further clarification, one leg of the U-shaped tool carries the air driven impact device while the other leg carries the anvil 73. While it is contemplated that the applicable anvil can have different surface configurations, an exemplary anvil is shown in the FIGS. 4 & 5. It is shown to have a shoulder or notch into which the top edge of a cap 74 a toot 69 is fitted. The working surface of the anvil is covered with removable copper cap 79 which is configured to follow the outline of the notch. The copper cap 79 should have a thickness of about 0.045 inches and should be work hardened. The notch configuration shown assists to retain the tooth and its to be removed cap 74 in a substantially rigid condition there against so that vibratory causing stress on the tooth itself is minimized. The leading edge of the chisel 72 is in abutment with the opposite side of the cap 74 of the tooth. This embodiment of FIG. 4 is useful in removing the caps on teeth wherein the caps are more firmly adhered due to the use of improved newer cements which do not readily fracture at the interface of the tooth and cap thereon. In such a situation the cap 74 is disintegrated and can not be used again.

FIG. 5 is illustrative of another embodiment. The leading edge 72 of the chisel is covered with a removable hard metal insert 75 having a cap configuration thereby giving the leading edge 72 a harder secondary leading edge 76. The secondary leading edge 76 is covered by a soft copper sheath or cap 77, said cap having preferably a thickness of about 0.016 inches. The copper cap 77 is bonded to the hard metal insert. This embodiment has been found to be particularly useful with regard to older crowns that are cemented with less adherent cements and are subject to fractioning under the aegis of vibratory action of the herein disclosed air driven motor.

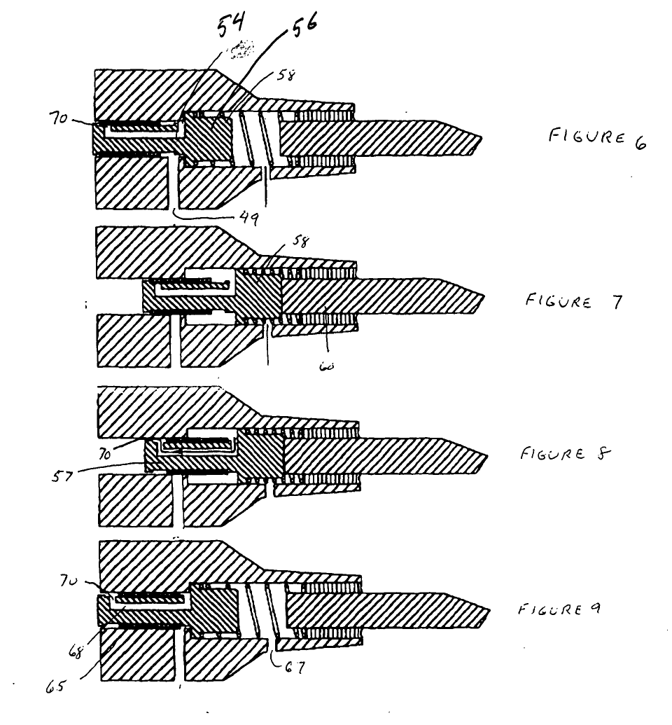

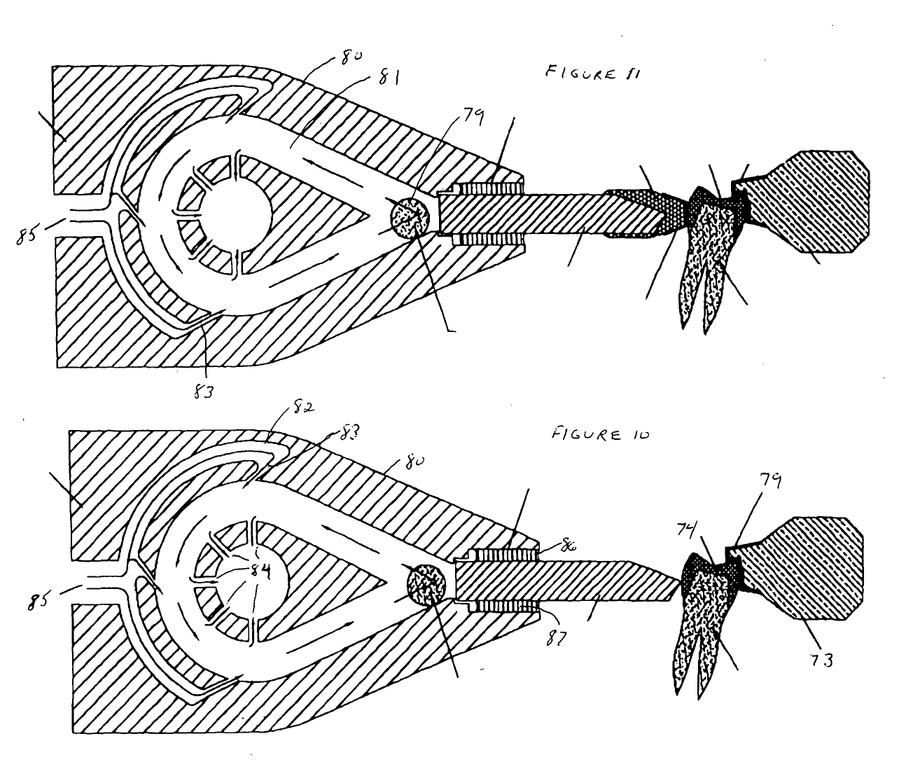

Attention is now directed to FIGS. 6 to 9 for a detailed consideration of the operation of the novel air driven impact tool of the present invention. In FIG. 6 the piston-hammer is to the left and the valve is to the left covering the air escape opening 70 and simultaneously opening the air under pressure conduit whereby air is admitted into first section 54 and behind the piston 56 of the hammer 58. In FIG. 7 the pressurized air drives the hammer 58 to the right to impact the top of the chisel. Then in FIG. 8 the valve 65 is carried on the stem 57 of the piston 56 and under inertia progresses independently to open up section 54 to the ambient air through conduit 68 in the stem 57 of the piston 56, thereby relieving the air pressure so that the helical spring 62 can drive the piston-hammer 56 &58 combination to the left. The valve 65 in FIG. 9 moves under inertia to the left to again close the opening 70 at the end of the conduit 68 in the stem of the piston thus to stop the venting of air, as in FIG. 6, while at the same time opening first section 54 to the flow of air under pressure through conduit 68. In the course of the reciprocation conduit 67 remains open to provide relief on the non pressurized side of the piston.

It is incumbent to become acquainted with an additional drive means to impact on the impact receiving end of a chisel with the working end or leading edge thereof in confronting relationship with one side of the cap of a tooth, which is to be removed. With this view, attention is now directed to FIGS. 10 and 11.

The actual impact treatment of FIG. 4 corresponds to the impact treatment area of FIG. 10. Likewise the impact treatment area of FIG. 5 corresponds to the treatment are of FIG. 11. However the impact drive means in both FIGS. 10 and 11 are the same, while the drive means is uniquely different in that it can be economically constructed and requires very few moving parts while still able to deliver good impact to the working chisel.

The drive means is an air driven hammer wherein the impact means is a steel ball 79 that is driven along a confining oval track 81 by suitably positioned jets of air along the perimeter of the track. The ball is thrust against the top or rear portion of the chisel and approaches the top of the chisel at an angle of 25 degrees to the axis of the chisel. Then the ball bounces away from the surface of the top of the chisel at an angle of 25 degrees to the axis of the chisel.

In FIGS. 10 and 11, a housing 80 is provided which has a substantially oval track 81 in the housing 80. A steel ball 82 transverses the track. The housing 80 has a concentric arcuate channel 82 radially displaced from said track opposite the position at which the chisel is mounted. The channel 82 is positioned around the track for only a portion thereof. The channel 82 has ingress port 85 for air under pressure which is distributed into the confines of the track 81 through a plurality of nozzles 83 detailed to deliver the blasts of air tangentially to the track whereby each nozzle delivers the air against the ball as it passes a nozzle. The track 81 of the housing 80 has a plurality of egress ports 84 which connect centrally radially inwardly with an egress collection conduit whereby the air under pressure is exhausted to ambient. The chisel is mounted through an opening 86 of the housing 80 which is opposite the ingress port 85. The chisel is mounted resiliently by an elastic mount 87.

It is to be understood that various other changes and modifications may me made without departing from the scope of the invention. The present invention being only limited by the claims which are appended hereto.

1. A device for disintegrating cement which adheres a dental fixture to a portion of a tooth, the device including:
first and second members for contacting opposed first and second sides respectively of said dental fixture; said second member having a malleable cap thereon; and
a motor for moving said first and second members towards and away from each other conforming said cap to the shape of second side of said dental fixture and thereby aiding in disintegration of said cement.

2. A device for disintegrating cement which adheres a dental fixture to a portion of a tooth, the device including:
first and second members for contacting opposed sides of said dental fixture; said first member having a first work hardenable cap thereon of a first thickness; and said second member having a second work hardenable cap thereon of a second thickness; said second thickness being greater than said first thickness; and
a motor for moving said first and second members towards and away from each other work hardening said caps and disintegrating said cement.

3. The device as defined in claim 2 in which said work hardenable caps are made substantially of copper.

4. The device as defined in claim 2 in which said tooth has an axis and said first and second members are for contacting said tooth perpendicular to the axis of said tooth.

5. The device as defined in claim 2 in which said second cap conforms to the surface of the dental fixture before becoming work hardened.

6. The device as defined in claim 5 in which said work hordenable caps are made substantially of copper.

7. The device as defined in claim 6 in which said motor provides a force resulting in a peak pressure on said dental fixture and said thicker copper second cap results in good holding characteristics while said thinner copper first cap permits the delivery of said force in a manner to spread said peak pressure.

8. A device for disintegrating cement which adheres a dental fixture to a portion of a tooth, the device including:
first and second members for contacting opposed sides of said dental fixture; said second member having a work hardenable cap thereon; and
a motor for moving said first and second members toward and away from each other work hardening said cap and disintegrating said cement.

9. The device as defined in claim 8 in which said work hardenable cap is made substantially of copper.

10. The device as defined in claim 8 in which said tooth has an axis and said first and second members are for contacting said tooth perpendicular to the axis of the tooth.

11. The device as defined in claim 8 in which said cap conforms to the surface of the dental fixture before becoming work hardened.

12. The device as defined in claim 11 in which said work hardenable cap is made substantially of copper.

13. The device as defined in claim 12 in which said motor provides a force resulting in a peak pressure on said dental fixture and said copper cap results in good holding characteristics while said first member permits the delivery of said force in a manner to spread peak pressure.

14. A work hardenable cap for use in a device for disintegrating cement which adheres a dental fixture to a portion of a tooth, the device including first and second members for contacting opposed sides of said dental fixture; said second member being adapted to receive said cap; said cap including:
a main portion made from work hardenable material for overlaying said second member to be work hardened to conform to the shape of a portion of the surface of said dental fixture so that forces applied to said dental fixture are spread evenly across said portion of said fixture aiding in the disintegration of said cement; and
an additional portion to hold said cap on said second member.

15. The work hardenable cap as defined in claim 14 which is substantially of copper.

16. The work hardenable cap as defined in claim 14 which is designed to conform to the surface of a dental fixture before becoming work hardened.

17. The work hardenable cap as defined in claim 16 which is substantially of copper.

18. An article of commerce for use in a device for disintegrating cement which adheres a dental fixture to a portion of a tooth, the device including first and second members for contacting opposed sides of said dental fixture; said first and second members adapted to receive a first and second cap; said article of commerce including:
said first work hardenable cap adapted to being received by said first member; said first work hardenable cap being of a first thickness; and
said second work hardenable cap being adapted to being received by said second member; said second work hardenable cap being of a second thickness; said second thickness being greater than said first thickness.

19. The article of commerce as defined in claim 18 in which said work hardenable caps are made substantially of copper.

20. The article of commerce as defined in claim 18 in which said second cap conforms to the surface of the dental fixture before becoming work hardened.

21. The article of commerce as defined in claim 20 in which said work hardenable caps are made substantially of copper.

22. A method of disintegrating cement which adheres a dental fixture to a portion of a tooth, the method includes the steps of:
providing first and second members for contacting opposed sides of said dental fixture;
providing a first work hardenable cap on said second member; and
moving said first and second members towards and away from other work hardening said cap and disintegrating said cement.

23. The method as defined in claim 22 in which said first work hardenable is made substantially of copper.

24. The method as defined in claim 22 in which said tooth has an axis and holding said first and second members perpendicular to the axis of said tooth during he moving step.

25. The method as defined in claim 22 in which said cap conforms to the surface of the dental fixture before becoming work hardened.

26. The method as defined in claim 22 also including the step of:
providing a second work hardenable cap on said first member; said second work hardenable cap being thinner than said first work hardenable cap.

27. The method as defined in claim 26 in which second work hardenable cap is made substantially of copper.

28. The device as defined in claim 1 wherein said motor comprises a housing, said housing having a perpendicular tubular conduit, said conduit connecting the housing with ambient, a chisel resiliently mounted in said conduit and extending from said housing, said chisel having a first remote end and a second proximate end; said chisel extending from said housing terminating in a working sharp edge at the said first remote end; said chisel having an impact receiving means at the proximate end, said housing having an eliptical tubular channel, said channel having an apex portion, said proximate end of said chisel terminating in a normal position relatively flush at the apex portion of said channel, a ball being positioned in said in channel, said ball having a diameter whereby it fits snugly in said channel, said channel being fitted with a plurality of nozzles adapted to provide pressurized air tangential to said channel and against the ball to thereby propel said ball in one direction and impact against the proximate end of the chisel when said ball is in the apex portion of the channel to thereby drive said working sharp edge in the direction of a crown of a tooth when said device is employed, said chisel being supplied with spring means to return the chisel to said normal position.

29. The device as defined in claim 28 wherein the apex portion of the channel is adapted and constructed whereby the said ball impacts the proximate end of the chisel at angle of about 25 degrees.

30. The device as defined in claim 29 wherein the apex portion of the channel is adapted an constructed whereby the said ball is deflected from the proximate end of the chisel at an angle of about 25 degrees.

31. The device as defined in claim 1 wherein said motor comprises a housing, said housing having a tubular conduit there through, said conduit having a first opening at one end and a second opening at an opposite end, a chisel resiliently mounted in said conduit and extending from said first end of said housing, said resiliently mounted chisel having a first remote end and a second proximate end; said chisel extending from said housing terminating in a working sharp edge at the said first remote end; said chisel having an impact receiving means at the proximate end, said conduit having a first section and axially therewith a second section, said second section having a larger diameter than said first section, a piston mounted in said second section and a stem mounted to an end thereof and extending into said first section, said piston having a hammer portion at the opposite side of the piston, said hammer being adapted to deliver a blow against the proximate end of said chisel when said stem and piston reciprocably drives said hammer, said first section of said housing having means for introducing air under pressure into said first section to thereby drive the stem, piston and hammer against the proximate end of the chisel, said stem having a having a longitudinal conduit means connecting the first section to ambient, said stem having slidable valve, said valve adapted to open said stem located conduit to ambient when in one position and to close stem located conduit when in another position whereby said first section can be pressurized with air to thereby drive said working sharp edge in the direction of a crown of a tooth when said device is employed, said chisel being supplied with spring mean to return the chisel to normal position.
